(19) United States
(12) Patent Application Publication
(10) Pub. No.: US 2020/0047967 A1
(43) Pub. Date: Feb. 13, 2020

(54) UNBLENDED PET FOOD PRODUCT AND METHOD FOR MAKING A PET FOOD PRODUCT

(71) Applicant: William M. Sherk, JR., Oakwood, OH (US)

(72) Inventor: William M. Sherk, JR., Oakwood, OH (US)

(73) Assignee: MiracleCorp Products, Dayton, OH (US)

(21) Appl. No.: 16/538,321

(22) Filed: Aug. 12, 2019

Related U.S. Application Data
(60) Provisional application No. 62/717,334, filed on Aug. 10, 2018.

(51) Int. Cl. B65D 77/06; B65B 25/00; B65B 1/04; A23K 40/00; B65D 81/32

(52) U.S. Cl. CPC B65D 77/06; B65B 25/00; B65D 81/3261; A23K 40/00; B65B 1/04

(57) ABSTRACT

A pet food product system including a storage device having an inner compartment and a pet food product positioned in the inner compartment. The pet food product includes a plurality of first pellets and a plurality of second pellets, wherein the first and second pellets are substantially unblended.

This application claims priority to U.S. Provisional Patent Application Ser. No. 62/717,334 filed on Aug. 10, 2018, the entire contents of which are hereby incorporated by reference.

The present disclosure is directed to a pet food product, and more particularly, to a pet food product with various ingredients that are packaged in an unblended manner.

### BACKGROUND

Pet food is often made of various ingredients, such as different pellets or the like, that are blended together. In order to provide such a pet food, various hoppers which store pellets of the same type can be utilized. The hoppers dispense pellets in the desired amounts which are then conveyed to a blending unit that blends the pellets by various means such as by centrifugal forces, mechanical means such as paddles or rakes, etc. The blended pet food is then introduced into a storage container, which is sealed and delivered to a store or pet owner.

It may be desired to process various different batches or blends of food product, which have different ingredients. However, some batches may be desired to be isolated from other batches to avoid contamination of certain ingredients that are or include allergens, or have undesirable taste or smell, or for other reasons. When a shared blending unit is used, trace or larger amounts of ingredients from an earlier batch may remain on or in the blending unit, which can contaminate the subsequent batch.

### SUMMARY

The present disclosure is directed to a pet food product and a method of making a pet food product where the pellets are unblended, and instead are directly introduced into the storage container without passing through a blending unit. Avoidance of a blending unit thus eliminates a source of potential contamination. More particularly, in one embodiment the invention is a pet food product system including a storage device having an inner compartment and a pet food product positioned in the inner compartment. The pet food product includes a plurality of first pellets and a plurality of second pellets, wherein the first and second pellets are substantially unblended.

### BRIEF DESCRIPTION OF THE DRAWINGS

FIG. 1 is a front perspective view of a bag, in an inverted position;

FIG. 2 is a front perspective view of the bag of FIG. 1, positioned in a box also in an inverted position;

FIG. 3 shows a divider being inserted into the bag and box of FIG. 2;

FIG. 4 shows the divider of FIG. 3 being removed from the bag and box of FIG. 3, after the bag and box have been filled;

FIG. 5 shows a bottom panel being secured to the bag of FIG. 4;

FIG. 6 shows the box of FIG. 5 with the flaps folded closed and being sealed;

FIG. 7 shows the box of FIG. 6 turned to its upright position;

FIG. 8 shows the bag removed from the box of FIG. 7, with front portions of the bag cut away for illustrative purposes;

FIG. 8A is a detail view of the area indicated in FIG. 8;

FIG. 9 is a side view of a system for filling the bag and box of FIG. 3;

FIG. 10 is a front perspective view of another system for filling the bag and box of FIG. 3;

FIG. 11 is a front perspective view of an alternate divider;

FIG. 12 illustrates the divider of FIG. 11 positioned in a bag; and

FIG. 13 is a front perspective view of another alternative divider.

### DETAILED DESCRIPTION

With reference to FIG. 1, the system and method may begin with a storage device or container 12, such as a flexible bag in one case, having an inner compartment 14. The bag 12 can have any of a wide variety of shapes and configurations, and can be made of paper, cardboard, polymers or the like such that the bag 12 is generally flexible and is manually deformable to the desired shape. In FIG. 1 the bag 12 is shown in a “box-like” configuration with generally planar sides since the bag 12 is next inserted into a storage device or container, such as a rectangular prism box 16, as shown in FIG. 2. The bag 12 in FIG. 1 is also shown in an inverted or upside-down configured from the configuration in which the bag 12 will be used by the user/pet owner. The bag 12 may include a top seal 18 (shown at the bottom of the bag 12 in FIG. 1), which can be manually open or torn to allow a user to access the contents of the bag 12.

As shown in FIG. 2, the bag 12 is inserted into the other storage device or container 16 having an inner compartment 20, such as a box in the illustrated embodiment. The box 16 can have a size, shape and/or volume the same as, or very similar to (slightly larger than) that of the bag 12 such that the bag 12 is closely received in the box 16. The box 16 can be made of any of variety of materials, including those outlined above for the bag 12, but may have greater stiffness and/or strength than the bag 12. The box 16 is also shown in an inverted configuration in FIG. 2 and may have opening features at its top (e.g. comparable to the top seal 18) that make the box 16 easier to open at its top as compared to its bottom after the box 16 is sealed.

It should be noted that either the bag 12 and/or the box 16 can be considered to constitute a storage device which is configured to receive and store a pet food product. In addition either the bag 12 and/or box 16 may be able to be used alone without the other, particularly if the bag 12/box 16 has sufficient stiffness that it can remain open during the filling process described below.

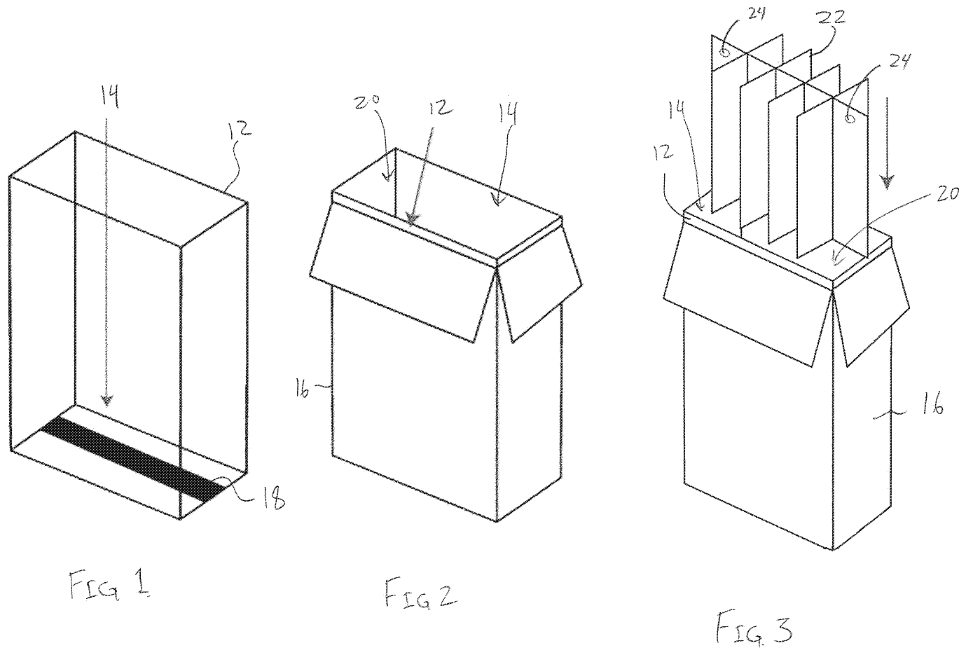

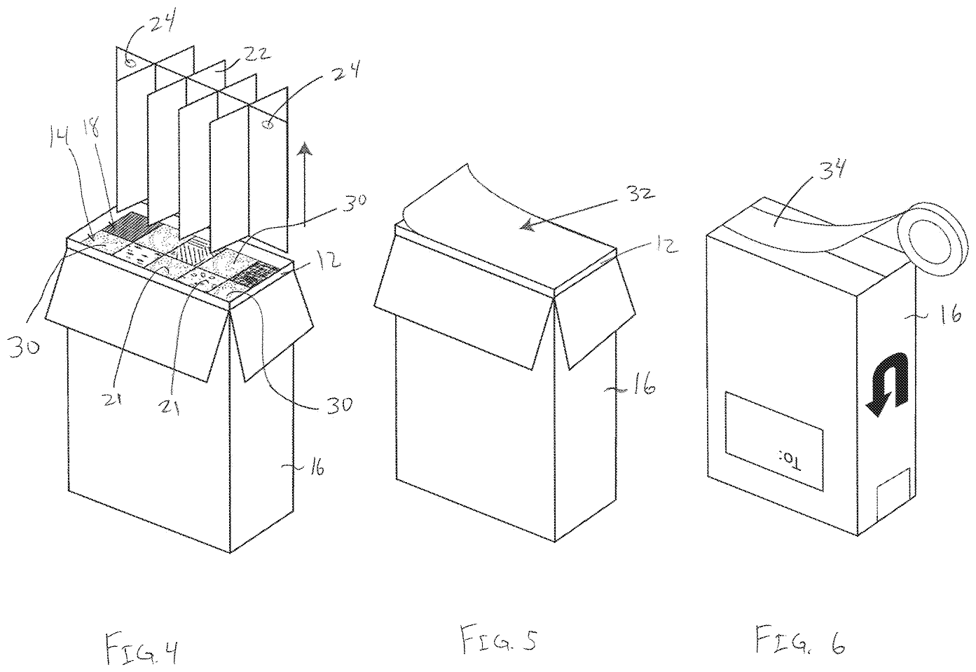

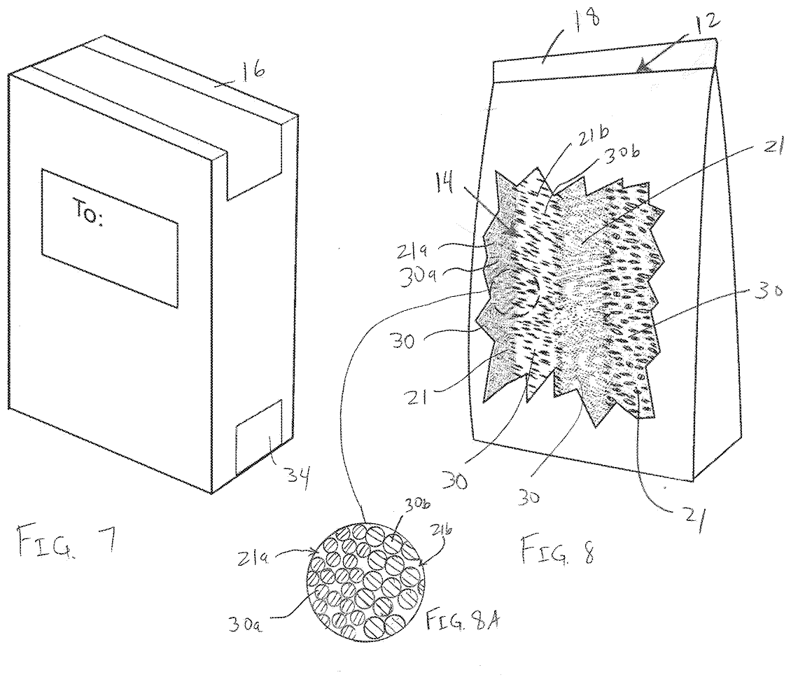

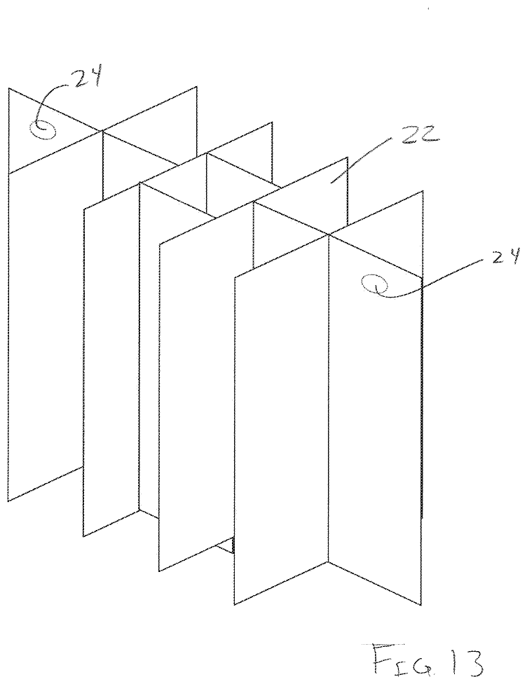

In any case, after the bag 12 and/or box 16 are in the configuration shown in FIG. 2, a divider 22, if desired to be utilized and as shown in FIG. 3, can be inserted into the inner compartment 14 of the bag 12. The divider 22 can be utilized to help to segregate different types of ingredients/pellets 30 of the pet food product into different zones, areas or volumes 21 (FIG. 4). In the illustrated embodiment, the divider 22 defines the plurality of zones 21 by dividing the inner compartment 14 into a plurality of sub-compartments 14′ (see FIG. 12) defined by the walls of the divider 22 and/or the walls of the bag 12. In the illustrated embodiment, the divider 22 extends the entire or generally the entire (e.g. at least about 90% in one case) of the height or longitudinal dimension of the bag 12/box 16 such that each sub-compartment 14′/zone 21 can correspondingly extend an entire height or generally an entire height of the bag 12/box 16.

The divider 22 can have any of a variety of configurations as shown for example in FIGS. 3, 4 and 11-13, or other configurations as desired, providing sub-compartments 14′/zones 21 of various different sizes and shapes. As shown in FIGS. 3, 4 and 13, in one embodiment the divider 22 can include cutouts 24 at opposite upper ends thereof to provide gripping handles to aid in removal of the dividers 22 from the bag 12/box 16. As shown in FIGS. 11 and 12, alternately, or in addition, the divider 22 can include upwardly-protruding tabs 27 that provide a gripping surface to aid in removal.

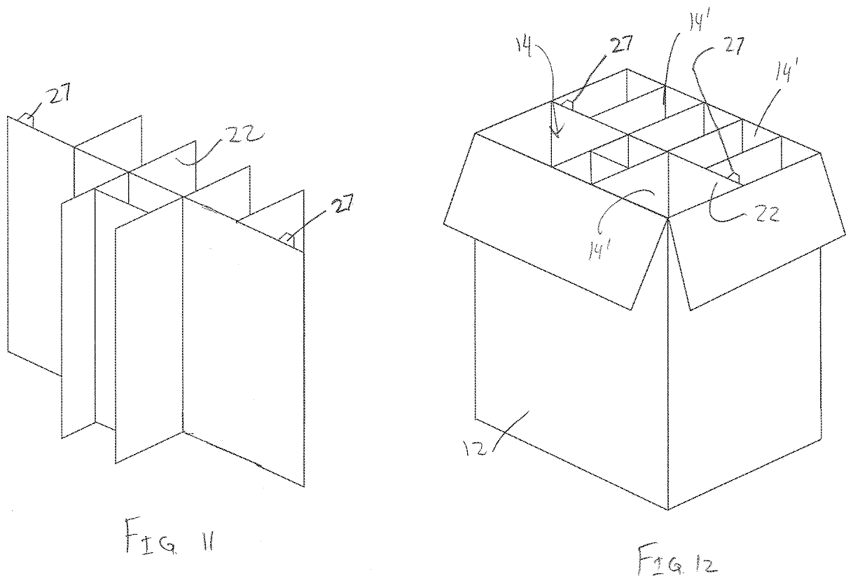

Once the divider 22 of desired configuration (if any) is inserted into the bag 12/box 16, as shown in FIG. 3, various ingredients/pellets 30 can be inserted into each sub-compartment 14′ defined by the dividers 22. With reference to FIG. 9, in one embodiment the dispensing system 31 includes a plurality of hoppers or dispensing portions 26, each of which can store a single ingredient and/or single type of solid pellet 30 therein. The bag 12/box 16 is positioned on a movable conveyor or the like 29 such that the bag 12/box 16 can be moved to various stations positioned below each hopper 26 so that the pellets 30/ingredients of that hopper 26 can be dispensed into the desired sub-compartment 14′, in the desired amounts. In the illustrated embodiment each hopper 26 dispenses its pellets 30 by gravity through a dispensing spout or filling device 28. However, it should be understood that the bag 12/box 16 can be filled with ingredients from the hoppers 26 by any of a wide variety of other means beyond a gravity-fed hopper. In addition, rather than moving the bag 12/box 16 relative to the hoppers 26, in one embodiment the hoppers 26 can be movable relative to the bag 12/box 16, or both the bag 12/box 16 and the hoppers 26 may be movable relative to each other. FIG. 9 illustrates a relatively simple filling station wherein the bag 12/box 16 is conveyed in a linear direction. However, the filling device, system and method can be more complex such that the bag 12/box 16 is conveyed in various differing directions, to and from hoppers 26 at various positions as shown in FIG. 10.

The pellets/ingredients 30 that are fed into the bag 12/box 16 can take a wide variety of forms of pet-edible solid pellets 30 of pet-grade food. In one embodiment, each pellet 30 is generally spherical, cylindrical or other extruded solid shape, and can have an average effective diameter (e.g. in one case, when the pellets 30 are not spherical, an equivalent spherical diameter for the same volume) of less than about one inch and/or greater than about 0.1 inch, to distinguish pellets 30 from broken-off particles, etc. Each pellet 30 can in one case have a volume of less than about 4 cubic inches and/or greater than about 0.004 cubic inches. In addition, the pellets 30 can each have a size, volume and/or weight that is generally similar to the other dispensed pellets 30 (e.g. dispensed from a different dispenser 26 and/or stored in a different sub-compartment 14′/zone 21). In one case, the pellets 30 have an average effective diameter and/or weight and/or volume that is within about 50 percent of an average effective diameter and/or weight and/or volume, respectively, of other ones of the pellets 30 that are dispensed and/or stored in the bag 12/box 16. Each type of pellet 30 (again, as dispensed by a dispenser 26 and/or stored in a sub-compartment 14′/zone 21) may contribute at least about 2% in one case, or at least about 5% in another case, or at least about 10% in another case, to the weight and/or volume of the total of all pellets 30 positioned in the bag 12/box 16. In one case the average particle size is determined by ISO (International Organization for Standardization) standard 9276-2:2014 and/or 19.120 which are incorporated by reference herein.

The pellets 30 can take the form of any of a wide variety of pet food product pellets including pet-edible materials/ingredients, including fruit, vegetables, protein, carbohydrates, vitamins, minerals, and other ingredients. Each of the different types of pellets 30 can in one case differ in at least one of size, weight, shape, color, composition or surface texture. In other cases, however, one or more of the different types of pellets 30 can be visually and/or tactilely indistinguishable even when made of different ingredients.

Differing pellets 30 having differing properties can be stored in the differing hoppers 26, that can be spaced apart from each other, and dispensed into differing sub-compartments 14′ of the bag 12/box 16, forming differing zones 21. For example, with reference to FIG. 9 in one case first pellets 30 are made primarily of fruit and/or vegetables are stored in the first hopper 26a, second pellets 30 are made primarily or entirely of proteins are stored in the second hopper 26b, etc. In the filling device or system 31 shown in FIGS. 9 and 10, each hopper 26 includes its own dispensing spout 28 such that no pellets 30 from another hopper 26 flow over any portion of the dispensing spout or filling device 28. In this manner, each of the pellets 30/ingredients can be physically isolated from each other during the entire filling/dispensing process. The bag 12/box 16 can, in one case, have a weight of between about 10 pounds and about 35 pounds when filled. In one case, an edible or non-edible treat or toy can be inserted into the bag 12/box 16 along with the food pellets 30 to provide a surprise gift to the pet or pet owner.

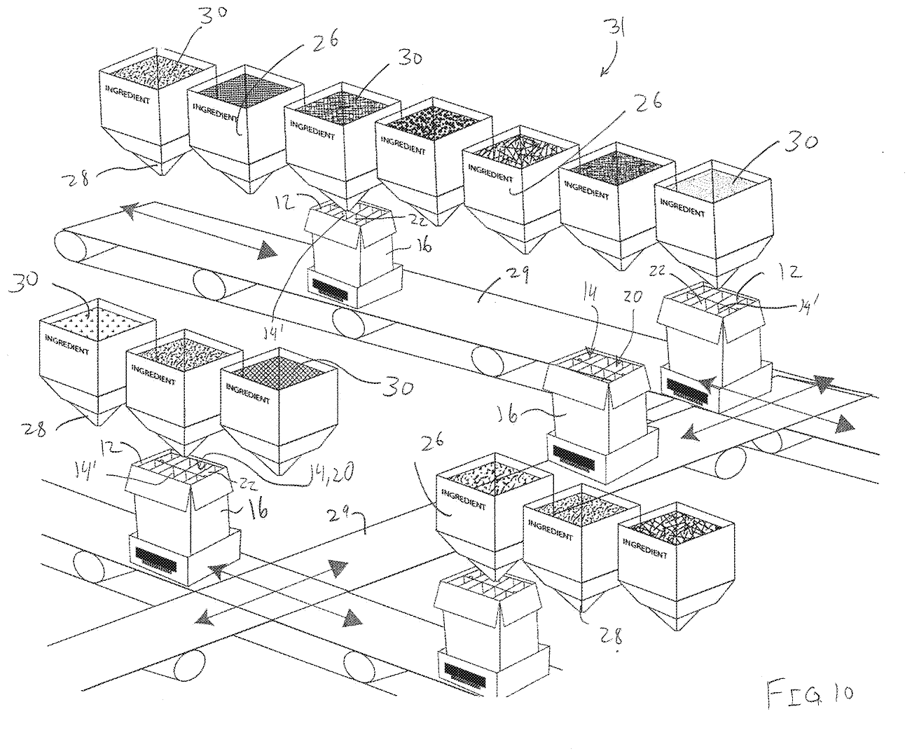

As shown in FIGS. 4 and 8, after the filling process is complete, the divider 22, if utilized, can be removed, and the different zones 21 of pellets 30 remain behind. As shown in FIG. 8A, pellets 30a of a first type, positioned in a first zone 21a, can be positioned adjacent to pellets 30b of a different type, positioned in a different, second adjacent zone 21b. In other cases, if desired, the divider 22 can remain in place while the bag 12/box 16 is sealed, shipped and delivered to further maintain the integrity of the zones 21. In yet another embodiment, the bag 12/box 16 does not include any divider 22 positioned therein during the filling process. In this case, differing types of pellets 30 can be added into the bag 12/box 16 at different times, and therefore the differing volumes/zones 21 in the bag 12/box 16 can be naturally formed in a layering process and may extend somewhat horizontally and/or be more undefined than the (at least initial) more strict segregation of zones 21 that can be provided by the dividers 22.

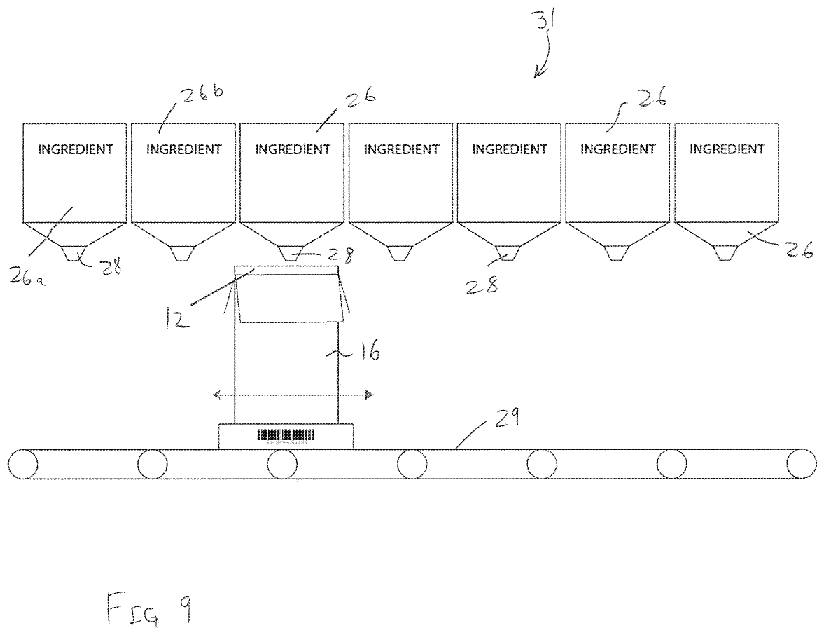

In any case, after the bag 12/box 16 of FIG. 4 is filled, a bottom panel 32 can be coupled to the bottom of the bag 12, as shown in FIG. 5. Next, as shown in FIG. 6, the bottom flaps of the box 16 are folded inwardly and secured, such as by an adhesive tape 34. As shown in FIG. 7, the bag 12/box 16 can then be inverted to its upright configuration and shipped to a customer/end-user/pet owner or to another location for pickup. The bag 12 and/or box 16 may include an area for information to be written or displayed thereon, such as information identifying the pet's name, the owner's name, personalized messages, etc.

Once received and desired to be used, the top of the box 16 may be able to be manually opened by the pet owner, and the box 16 can have opening features to enable the box 16 to be more easily manually opened at its top end than at its bottom end. Similarly, the bag 12, positioned inside the box 16, can be configured to be more easily manually opened, such as by tearing, ripping, opening along a perforated line, tear guide line, tear string, etc., which features can be provided by the top seal 18 in one case. As shown in FIG. 8, the bag 12 can be removed from the box 16 for access, use and storage by the user. Alternatively, if desired the user may retain the bag 12 inside the box 16, even after the bag 12 and box 16 are opened.

As shown in FIGS. 4 and 8, after the ingredients/pellets 30 are positioned in the bag 12, the bag 12 can include a plurality of ingredients/pellets 30 that are unblended or substantially unblended, and forming various zones 21. In particular, in the illustrated embodiments each zone 21 may include only, or substantially only, ingredients/pellets 30 of the same type.

During the dispensing process it is possible that one or more pellets 30 may inadvertently enter into a sub-compartment 14′/zone 21 intended for another pellet type and/or the zones 21 may lose some integrity over time due to shifting or settling of contents. However, the system and method may be configured such that at least about 90 percent of the pellets 30, by weight/volume, in a given sub-compartment 14′/zone 21 are pellets 30 of the same type. In another embodiment, at least a majority of the weight/volume of a single type of pellets 30 in the bag 12 are contained within a sub-compartment 14′/zone 21 that consists of at least about 90 percent of those pellets 30, by weight/volume. In yet another embodiment, at least about 90 percent of the pellets 30 of a single type contained within the bag 12 are positioned within a sub-compartment 14′/zone 21 that is at least about 90 percent of those associated pellets 30 by weight/volume.

As outlined above, the divider 22 may not necessarily be used during filling, and in this case the sub-compartments 14′/zones 21 positioned in the bag 12/box 16 can form a more undefined shape that may be more horizontally-oriented than the vertically-oriented sub-compartments 14′/zones 21 shown in FIGS. 4 and 8. Nevertheless, since all the pellets 30 of a given type can be filled in the bag 12/box 16 at a single time, it is possible to draw or define a three dimensional continuous “zone” or volume 21 with real and/or imaginary boundaries which can capture, for example, at least about 90 percent of pellets 30 of that type in the bag 12, or meet the other parameters outlined above which describe the segregated/unblended nature of the ingredients/pellets 30 in the bag 12/box 16.

The zones 21 may in one case extend generally vertically or generally parallel to a greatest dimension of the bag 12/box 16. For example in one case each zone 21 extends at least about 25% of the height of the bag 12/box 16 and/or the height the contents of the bag 12/box 16, or in another case at least about 50% of the height, or in another case at least about 75%, or in yet another case 100% of the height.

In one embodiment, a mixing spout (not shown) can be packaged with and/or coupled to the bag 12 and/or box 16, where the mixing spout is coupleable to a dispensing opening of the bag 12 and/or box 16. The mixing spout can be configured to be coupled to a top opening of the bag 12 and providing a mixing effect, such as by providing centrifugal mixing, when the ingredients in the bag 12 are poured through the spout. In another embodiment, however, no mixing spout is used.

In one embodiment the system and method disclosed herein can be used in conjunction with a customized pet food product method or system. In particular, a computerized custom ordering system can be implemented and maintained online and be accessible via a web page over the internet. The system can prompt a user to provide information regarding the pet's breed, age, activity level, weight, and other parameters. After receiving the user's input, the system can formulate a specific mix of ingredients 30/pellets and supply the proposed blend to the user, which the user can then either accept or modify as desired. Alternatively, a user can create their own customized blend from scratch by directly selecting ingredients/pellets 30 and their percentages. The system and method can include limits to ensure that in any case the end result remains compliant with relevant regulations relating to the content of feed or pet food, such as those implemented by the Association of American Feed Control Officials (AAFCO), which are incorporated by reference herein.

In the use of a customized system such as that described above, the hoppers 26 and dispensing system can be required to dispense batches with varying different types of ingredients. For example, two consecutive, three consecutive, or four or more consecutive batches can be created and dispensed that are different from each other in terms of at least the contents and/or ratio of the various pellets 30 The current system and method easily enables such a highly customized dispensing system, without risk of contamination between different types of ingredients, and without having to clean a common blending unit.

Moreover it should be understood that while each hopper 26 can include and dispense only a single type of pellet 30, if desired one or more hoppers 26 can include multiple types of pellets 30 that have been pre-blended. The advantages of the current system and method described above, such as avoiding a common blending unit are still provided, as the pre-blending of multiple pellets 30 can be carried out safely at a remote position and/or in a manner which does not present a risk of contamination. Thus when a hopper with pre-blended pellets 30 is utilized, certain zones in the bag 12/box 16 can include substantially only pellets 30 of a certain type, while other zones can include blended pellets 30.

As outlined above, many prior systems blend ingredients in a blending unit or the like prior to positioning the blended ingredients into a single-compartment bag. However, the blending of ingredients can lead to contamination of different batches. The present system and method, where each unblended ingredient can be directly introduced into the bag, provides a system in which different batches made of different ingredients can be easily implemented. The system and method also lends itself to use with a customized process where the pet owner or the like can customize the desired blend.

What is claimed is:

1. A pet food product system comprising:
a storage device having an inner compartment;
pet food product positioned in the inner compartment and including a plurality of first pellets and a plurality of second pellets, wherein the first and second pellets are substantially unblended.

2. The food product system of claim 1 wherein the first pellets differ from the second pellets in at least one of size, shape, color, surface texture, or composition.

3. The food product system of claim 1 wherein the first pellets are made primarily of at least one of fruit, vegetables, proteins, carbohydrates, vitamins or minerals, and wherein the second pellets are primarily made of at least one of fruit, vegetables, proteins, carbohydrates, vitamins or minerals that is different from the first pellets.

4. The food product system of claim 1 wherein the first and second pellets are substantially unblended such that a majority by weight of each of the first and second pellets in the storage device are contained within an associated continuous volume that is about least about 90% of the associated pellets by weight.

5. The food product system of claim 1 wherein the first and second pellets are substantially unblended such that about 90% of each of the first and second pellets in the storage device are contained within an associated continuous volume that is about least about 90% of the associated pellets by weight.

6. The food product system of claim 1 wherein the pet food product includes a plurality of third pellets, wherein the first, second and third pellets are substantially unblended.

7. The food product system of claim 1 wherein the system further includes a divider positioned in the inner compartment that divides the inner compartment into a first sub-compartment and a second sub-compartment, wherein said first sub-compartment includes substantially only first pellets, and wherein said second sub-compartment includes substantially only second pellets.

8. The food product system of claim 1 wherein the storage device lacks any dividers positioned in the inner compartment that divide the inner compartment into a plurality of sub-compartments with pellets positioned therein.

9. The food product system of claim 1 wherein the first pellets and second pellets are each a solid having an average effective diameter of less than about 1 inch and greater than about 0.1 inch.

10. The food product system of claim 1 wherein the first pellets have an average volume that is within about 50% of an average volume of the second pellets.

11. The food product system of claim 1 wherein the storage device is a generally closed bag that is manually openable, and wherein between about 10 lbs. and about 35 lbs. of pet food product is stored therein.

12. The food product system of claim 1 wherein the system further includes a mixing spout coupleable to the storage device and configured to mix said first and second pellets when said first and second pellets are poured out of said storage device through said mixing spout.

13. The food product system of claim 1 wherein the first and second pellets are positioned in first and second zones, respectively, wherein each zone extends generally vertically along a height of the storage device, and wherein each zone includes pellets therein other than the first or second pellets.

14. A pet food product system comprising:
a storage device having an inner compartment;
a first continuous volume defined in said inner compartment, wherein said first volume includes substantially only a first type of pet food pellets therein, and wherein at least about 90% of the first type of pet food pellets positioned in the storage device are positioned in the first volume; and
a second continuous volume defined in said inner compartment, wherein said second volume includes substantially only a second type of pet food pellets therein and wherein at least about 90% of the second type of pet food pellets positioned in the storage device are positioned in the second volume.

15. A method for making a pet food product comprising:
accessing a storage device having an inner compartment;
placing a plurality of first pellets into the inner compartment; and
placing a plurality of second pellets into the inner compartment such that the first and second pellets are substantially unblended.

16. The method of claim 15 further comprising, prior to the first and second placing steps, providing a filling device having a first dispensing portion and a second dispensing portion, and wherein the first placing step includes placing the plurality of first pellets into the inner compartment via said first dispensing portion, and wherein the second placing step includes placing the plurality of second pellets into the inner compartment via said second dispensing portion, and wherein the method further comprises, before the first accessing step, receiving a customized order for a pet food product via a computerized custom ordering system, and wherein the first and second placing steps are carried out in accordance with the customized order.

17. A method for filling a storage device with a pet food product comprising:
accessing a filling device having a first dispensing portion and a second dispensing portion;
accessing a storage device having an inner compartment;
directly placing a plurality of first pellets into the inner compartment via said first dispensing portion; and
after the first placing step is complete, directly placing a plurality of second pellets into the inner compartment via said second dispensing portion.

18. The method of claim 17 further comprising the step of, after the first placing step and before the second placing step, moving at least one of the filling device or the storage device relative to the other one of the filling device or the storage device.

19. The method of claim 17 wherein the first placing step includes placing the plurality of first pellets into a first continuous volume of the inner compartment, wherein the second placing step includes placing a plurality of second pellets into a second continuous volume of the inner compartment such that the first and second pellets are substantially unblended, and wherein the first pellets differ from the second pellets in at least one of size, weight, shape, color, surface texture or composition.

20. The method of claim 17 wherein the second portion of the filling device is spaced away from the first dispensing portion of the filling device such that, in the second placing step, no portion of the second pellets flow over any portion of the filling device that are flowed over by the first pellets in the first placing step.
